(19) United States
(12) Patent Application Publication
(10) Pub. No.: US 2011/0260566 A1
(43) Pub. Date: Oct. 27, 2011

(54) ROTATING ELECTRICAL MACHINE

(75) Inventors: Erik Odvarka, Columbus, IN (US); Peethamparam Anpalahan, Brentwood (GB); Neil L. Brown, Holbeach (GB); Richard J. Gray, Sleaford (GB); Andy Hutchinson, Shepshed (GB); Abdeslam Mebarki, Stamford (GB); Gurpreet Saini, Peterborough (GB); Krzysztof Wejrzanowski, Stamford (GB)

(73) Assignee: CUMMINS GENERATOR TECHNOLOGIES LIMITED, Stamford (GB)

(21) Appl. No.: 13/131,826

(22) PCT Filed: Nov. 26, 2009
(86) PCT No.: PCT/GB2009/002777

§ 371 Date: Jul. 18, 2011

(30) Foreign Application Priority Data
Nov. 28, 2008 (GB) 0821815.8
Jul. 31, 2009 (GB) 0913430.5

(51) Int. Cl. H02K 21/24; H02K 15/02

(52) U.S. Cl. 310/156.12; 29/598

(57) ABSTRACT

A rotor disc is disclosed for an axial flux permanent magnet rotating electrical machine. The rotor disc (12) comprises a plurality of laminations in a radial direction through the rotor disc, and a plurality of slots which pass radially through successive laminations for accommodating permanent magnets (14). The rotor disc may be formed from a spirally wound strip of material, or from groups of laminations.

The present invention relates to axial flux permanent magnet rotating electrical machines.

Rotating electrical machines, such as motors and generators, generally comprise a rotor and a stator, which are arranged such that a magnetic flux is developed between the two. In a permanent magnet (PM) type machine, a number of permanent magnets are usually mounted on the rotor, while the stator is provided with stator windings. The permanent magnets cause a magnetic flux to flow across the air gap between the rotor and the stator. In the case of generator operation, when the rotor is rotated by a prime mover, the rotating magnetic field results in an electrical current flowing in the stator windings, thereby generating the output power. In the case of motor operation, an electrical current is supplied to the stator windings and the thus generated magnetic field causes the rotor to rotate.

Permanent magnet type machines have many advantages, including high power density, high efficiency, compact size and ease of manufacture. However, a significant disadvantage of permanent magnet machines is the lack of field control within the machine. The lack of field control can result in the output voltage varying with load current when the machine is operated as a generator. This poor voltage regulation is unacceptable for some load types, limiting the application of permanent magnet machines.

When a permanent magnet machine is operated as a motor, the electromotive force (emf) generated within the motor increases with speed. The supply voltage to the motor is required to be greater than this internally generated emf, which requires a larger and more expensive converter and requires a higher DC bus voltage. A known strategy for minimising converter costs is to reduce the internally generated emf by suppressing the field within the machine by orientating the armature field produced by the armature current. This is known as ‘field weakening’ control.

For applications that require a combination of motor/generator operation such as traction applications, the ability to control the field is becoming increasingly important. For example overload conditions can be accommodated by increasing the field within the machine rather than increasing armature current thus minimising converter costs. In addition system efficiency improvements may be made as the flexibility of field control can minimise losses within the machine and converter for different operating speeds and torques.

Axial flux rotating electrical machines differ from conventional radial flux machines in that the magnetic flux between the rotor and the stator runs parallel to the mechanical shaft. Axial flux machines can have several advantages over radial flux machines, including compact machine construction, better integration with an engine, high power density, and a more robust structure.

WO 02/056443, the subject matter of which is incorporated herein by reference, discloses a rotor disc for an axial flux permanent magnetic rotating electrical machine. The rotor disc comprises a plurality of permanent magnets which are held in place by means of a spider formed from a resiliently deformable material such as nylon.

EP 1 503 478, the subject matter of which is incorporated herein by reference, discloses a similar arrangement to that of WO 02/056553, with the addition of wedge members to pin down the magnets and accommodate any tolerance.

It would be desirable to provide an axial flux permanent magnet rotating electrical machine in which the magnets were mechanically secure even under high centrifugal forces. It would also be desirable to provide an axial flux permanent magnet rotating electrical machine which facilitated control of the level of flux in the machine. In addition, it would also be desirable to provide an axial flux permanent magnet rotating electrical machine in which the flux concentration of the magnets could be improved.

An object of the invention is to address electromagnetic and mechanical issues related to the rotor of an axial-flux permanent magnet machine.

According to a first aspect of the present invention there is provided a rotor disc for an axial flux permanent magnet rotating electrical machine, the rotor disc comprising a plurality of laminations in a radial direction through the rotor disc, and a plurality of slots which pass radially through successive laminations for accommodating permanent magnets.

The present invention may provide the advantage that, by accommodating the permanent magnets within slots, greater mechanical stability may be achieved. The present invention may also provide the advantage that a better field weakening range may be achieved where field weakening techniques are used. Furthermore, the present invention may allow a magnet arrangement in which the flux concentration can be increased, which may result in an increased air gap flux density. This may allow the power density of the machine to be increased, which may reduce the total weight and size of the machine. In addition, the present invention may avoid chipping of the magnet corners which might otherwise occur due to their mechanical loading.

By providing a laminated rotor disc, iron losses in the rotor disc may be reduced, in particular by reducing eddy currents. By providing a plurality of laminations in a radial direction through the rotor disc, successive laminations may be in a direction which is perpendicular to the main magnetic field, which may help to reduce the generation of eddy currents. Furthermore, a laminated design may provide flexibility by allowing the size of the magnets to be adjusted to meet the required specification.

In one embodiment the slots run radially through the inside of the rotor disc, which may allow the permanent magnets to be enclosed within the rotor disc.

The slots may be open at the outer circumference of the rotor disc. This can allow the permanent magnets to be inserted radially into a pre-formed rotor disc, which may facilitate manufacture of the rotor.

The laminated rotor disc may be formed, for example, from a spirally wound strip of material such as iron or steel. This may facilitate manufacture of the laminated rotor disc. The strip of material may be punched to make pockets for the magnets prior to forming the laminated rotor disc. The strip of material may comprise a coating of resin, which may help to fill any voids in the assembled rotor disc, and give mechanical strength.

Preferably, means are provided for holding successive laminations together. For example, radial bolts or pins may pass through successive laminations, or laser welding may be used to join successive laminations together. Alternatively or in addition, a lamination may comprise a projection which protrudes into a space in an adjacent lamination. For example, a projection may protrude into the space created by a corresponding projection in an adjacent lamination. This may allow successive laminations to be locked to each other, which may help prevent slippage between the laminations.

The slots may be at least partially closed in an axial and/or circumferential direction. In one embodiment, the slots are closed in both an axial and circumferential direction, so that the magnets are enclosed in the laminations.

The slots may have a profile which corresponds to the profile of the magnets. For example, where the magnets have a rectangular profile, the profile of the slots may also be rectangular. However, the slots may be rounded outwardly at the corners. This may relieve stress on laminations in the rotor disc and may help to prevent damage to the corners of the magnets when they are inserted into the slots

According to another aspect of the invention there is provided a rotor comprising a rotor disc in any of the forms described above, and a plurality of permanent magnets in the slots in the rotor disc.

Preferably the permanent magnets are enclosed in the rotor disc, which may help to ensure mechanical stability under high centrifugal forces.

The rotor may further comprise a retaining ring around the circumference of the rotor disc. Where the slots are open at the outer circumference of the rotor disc, the retaining ring can be used to retain the magnets within the slots. The retaining ring is preferably made of a non-magnetic material such as stainless steel. The retaining ring may be secured to the rotor disc by means of radial bolts or pins or other securing means, or may be tightened around the rotor disc without the use of any additional securing means.

The retaining ring may comprise a plurality of magnetic elements. This may enable a position sensing technique, for example, a Hall-effect position sensing technique. This may allow the position of the rotor to be determined, in order to locate the rotor position with respect to the stator armature flux. Alternatively, the rotor may comprise a magnetic outer ring with a plurality of protuberances to enable a Hall-effect position sensing technique.

In order to produce a laminated rotor design, the rotor disc may be spiral wound onto a rotor hub. Thus the rotor may further comprise a rotor hub, and the rotor disc may be spiral wound onto the rotor hub. This may provide a convenient way of manufacturing the rotor.

The rotor may further comprise a plurality of radial bolts which pass through the rotor disc to the rotor hub. This arrangement can secure the rotor disc to the rotor hub, and successive laminations to each-other. In one embodiment the radial bolts pass through a retaining ring, through the rotor disc, and into the rotor hub. This may allow the retaining ring, magnets, rotor disc and rotor hub to be held together using one set of bolts. In another embodiment the radial bolts pass through the rotor disc and into the rotor hub, but do not pass through the retaining ring. This arrangement may reduce the stress on the retaining ring, while holding the laminations together.

The rotor hub and rotor disc may be provided with corresponding protrusions and indentations which interlock with each other. For example, the rotor hub may be provided with castellations which interlock with indentations in the rotor disc, or vice versa. This may help to prevent any peripheral slip and/or any axial movement of the rotor disc relative to the rotor hub. In addition this may help to ensure that the laminations are locked together.

The rotor hub may be provided with a step on its outer surface, and an end of a (spirally wound) lamination may be butted against the step. Preferably the depth of the step is approximately equal to the thickness of a lamination. The step may run axially, or at an angle, and preferably corresponds to the profile of the end of the lamination. This can allow a spirally wound rotor disc to be fully supported by the rotor hub around its entire circumference, which may increase the stability of the rotor disc.

The rotor may further comprise a filling agent in the slots. The filling agent may improve mechanical rigidity of the rotor, and may help to avoid chipping of the magnet corners. The filling agent may be a ferromagnetic filling agent, which may help to ensure a low reluctance path for the magnetic flux. However, the filling process may be difficult to control if the filling agent has magnetic particles which are attracted towards the magnets and for this reason a non-magnetic gap filling agent may be preferred. The filling agent preferably has the properties of elasticity and resistance to high temperatures, and does not react with the rotor or magnet materials.

In conventional axial flux permanent magnet machines, the poles of the permanent magnets are orientated in an axial direction. This design is conventionally used so that the permanent magnets face the stator. However, in an embodiment of the invention, the permanent magnets have poles which are orientated in a circumferential direction within the rotor disc. It has been found that this can allow the thicknesses of the magnets to be increased, which may increase the air gap flux density for a given rotor thickness. This may increase the power density of the machine, which may allow the total weight and total size to be reduced.

The above feature of the invention may also be provided independently, and thus, according to another aspect of the invention there is provided a rotor for an axial flux permanent magnet rotating electrical machine, the rotor comprising at least one rotor disc and a plurality of permanent magnets, wherein the permanent magnets have poles which are orientated in a circumferential direction.

In one embodiment, the slots in the rotor disc are open on a side of the rotor disc which faces away from the stator, and the rotor further comprises a back plate which closes the slots. The back plate may reduce the amount of leakage flux, and thus this embodiment may provide a reduction in leakage flux in comparison to some previous designs. Furthermore, the design may be easier to manufacture, and may result in a mechanically more stable rotor.

The back plate is preferably formed from a non-magnetic material such as aluminium, plastic, or any other suitable material. This can allow the leakage flux from the magnets to be reduced, since a non-magnetic material is present on the side of the rotor away from the stator.

The back plate may be cast onto the laminations. This may provide a convenient way of manufacturing the rotor, and help to ensure mechanical stability.

The laminations and back plate may comprise a protrusion and corresponding recess for holding the laminations and back plate together. For example, the back plate may comprise a plurality of protrusions, and the laminations may comprise a plurality of corresponding recesses, or vice versa. The recesses may have an interior width which is greater than the width of the opening, while the protrusions may be narrower at the base, in order to provide an interlocking feature.

In one embodiment, the laminations are formed in groups of laminations spaced circumferentially about a rotor hub, and each permanent magnet is located between two groups of laminations. Thus, in this embodiment, the slots are formed between adjacent groups of laminations. A back plate may be provided on the side of the rotor away from the stator. This arrangement may provide a reduction in leakage flux in comparison to some previous designs. It may also allow the magnet mass to be reduced, thereby reducing the inertia of the rotor. Furthermore, the design may be easier to manufacture, and may result in a mechanically more stable rotor.

In the above embodiment, the slots may be at least partially open on a side of the rotor that faces the stator. The groups of laminations may comprise flanges on the side of the rotor that faces the stator, for retaining the permanent magnets.

The permanent magnets may be tapered, with a circumferential width which decreases towards the centre of the rotor. This may allow the overall magnet mass to be reduced, thereby reducing the inertia of the rotor.

According to another aspect of the invention there is provided a rotor disc for an axial flux permanent magnet rotating electrical machine, the rotor disc comprising a plurality of groups of laminations spaced circumferentially about a rotor hub, a plurality of permanent magnets, each located between two groups of laminations, and a rotor back plate which closes one side of the rotor.

In any of the above arrangements the rotor may comprise two rotor discs for mounting co-axially either side of a stator.

According to another aspect of the invention there is provided an axial flux permanent magnet rotating electrical machine comprising a stator and a rotor in any of the forms described above.

The machine may comprise an air gap between the stator and the rotor, and the stator may comprise stator windings. In this case, the machine may further comprise means for adjusting the phase of a current in the stator windings in order to control flux in the air gap. This may allow flux weakening operation.

The machine may further comprise a Hall-effect sensor for determining the position of the rotor relative to the stator.

According to another aspect of the invention there is provided a method of manufacturing a rotor disc for an axial flux permanent magnet rotating electrical machine, the method comprising forming a rotor disc from a plurality of laminations which run in a radial direction through the rotor disc, the laminations having a plurality of slots which pass radially through successive laminations for accommodating permanent magnets.

The method may comprise spirally winding a strip of material onto a rotor hub. Alternatively, the method may comprise forming the rotor disc from groups of laminations.

The slots may be open at an outer circumference of the rotor disc, and the method may further comprise inserting permanent magnets into the slots in a radial direction.

The method may further comprise casting a back plate onto the rotor disc.

Features of one aspect of the invention may be applied to any other aspect. Any of the apparatus features may be provided as method features and vice versa.

Preferred features of the present invention will now be described, purely by way of example, with reference to the accompanying drawings, in which:

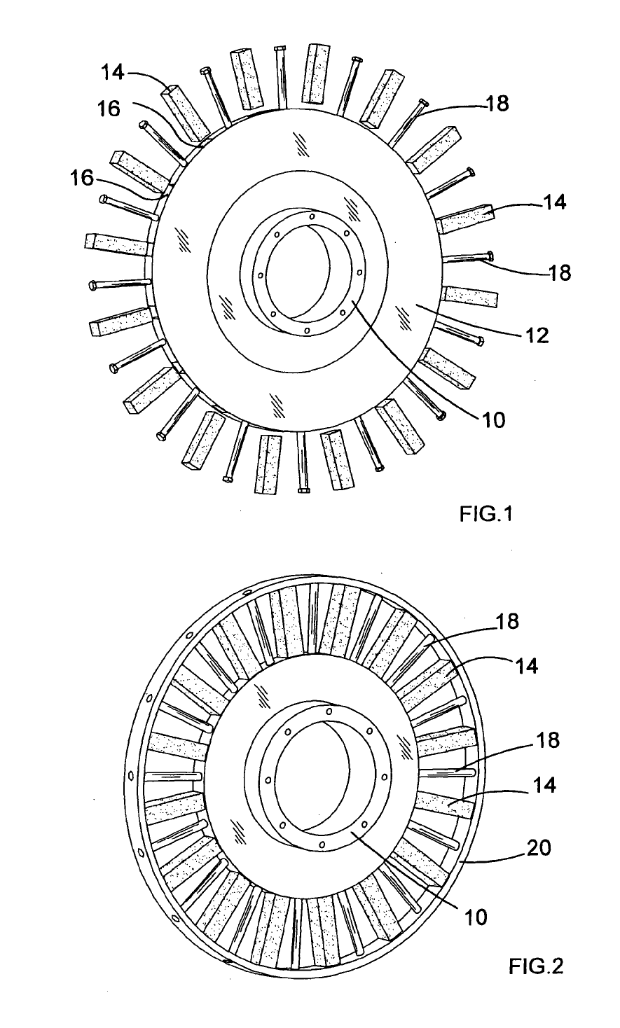

FIG. 1 shows parts of a rotor for an axial flux permanent magnet rotating electrical machine;

FIG. 2 shows parts of the rotor of FIG. 1;

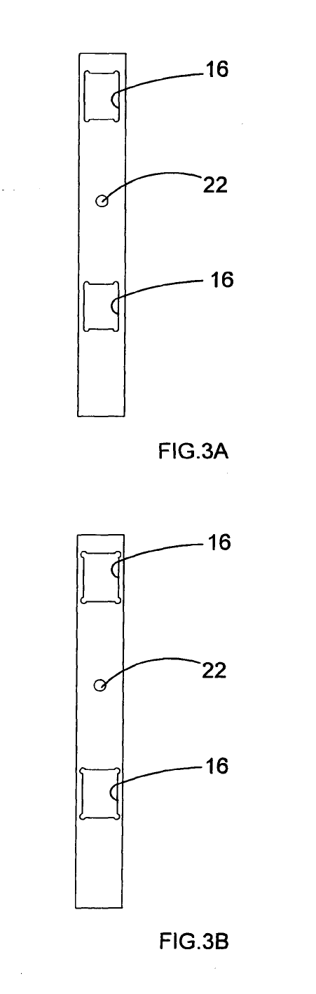

FIGS. 3A and 3B show profiles of slots for accommodating permanent magnets;

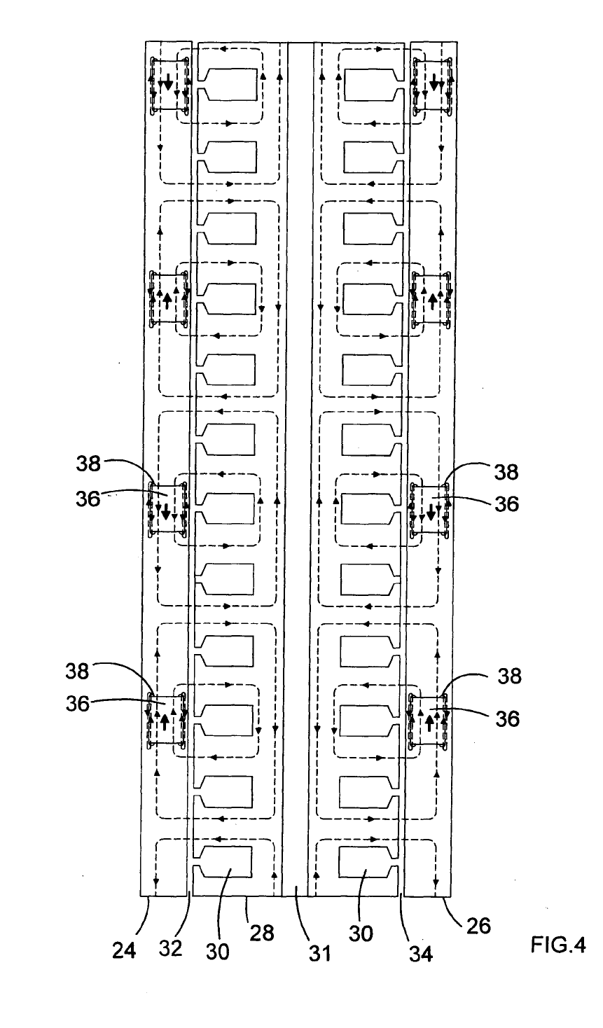

FIG. 4 shows an end view of part of an axial flux permanent magnet rotating electrical machine;

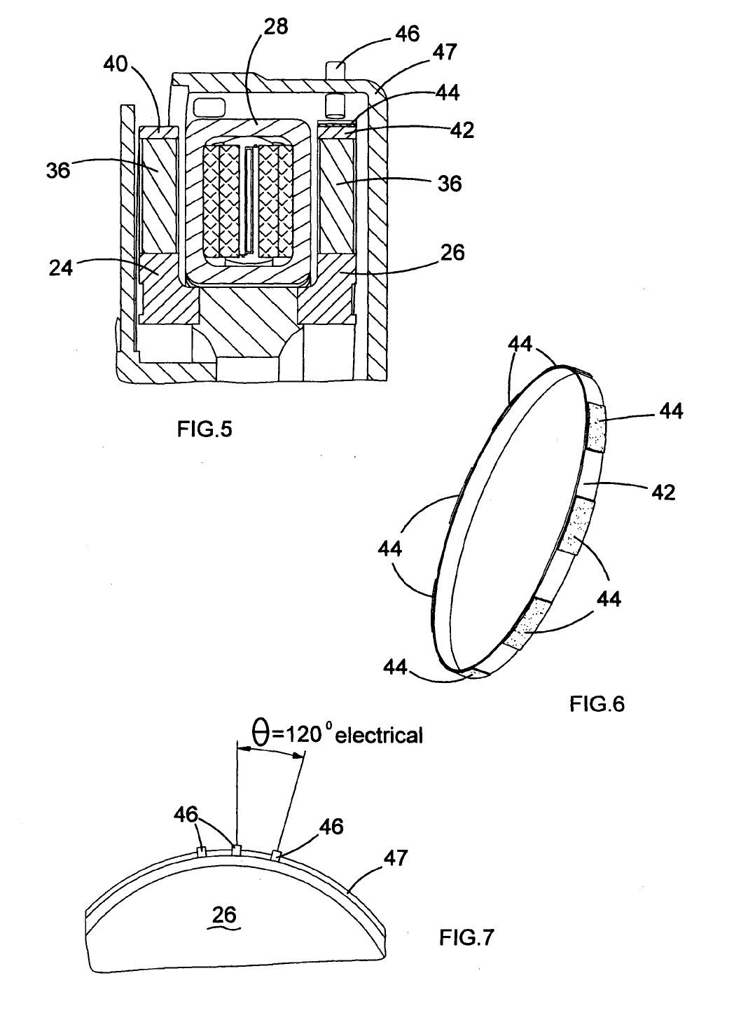

FIG. 5 shows a cross section of part of an axial flux permanent magnet rotating electrical machine;

FIG. 6 shows a retaining ring;

FIG. 7 shows the positions of three Hall effect sensors;

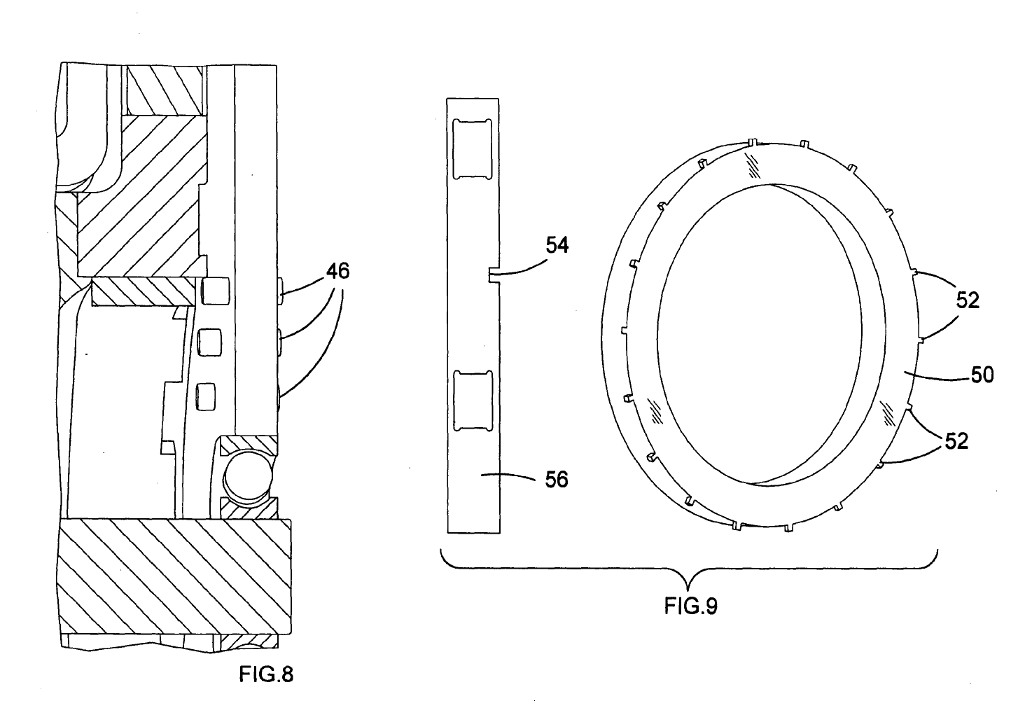

FIG. 8 shows an alternative technique for sensing the position of the rotor;

FIG. 9 shows parts of a rotor hub and a profile of a corresponding rotor disc;

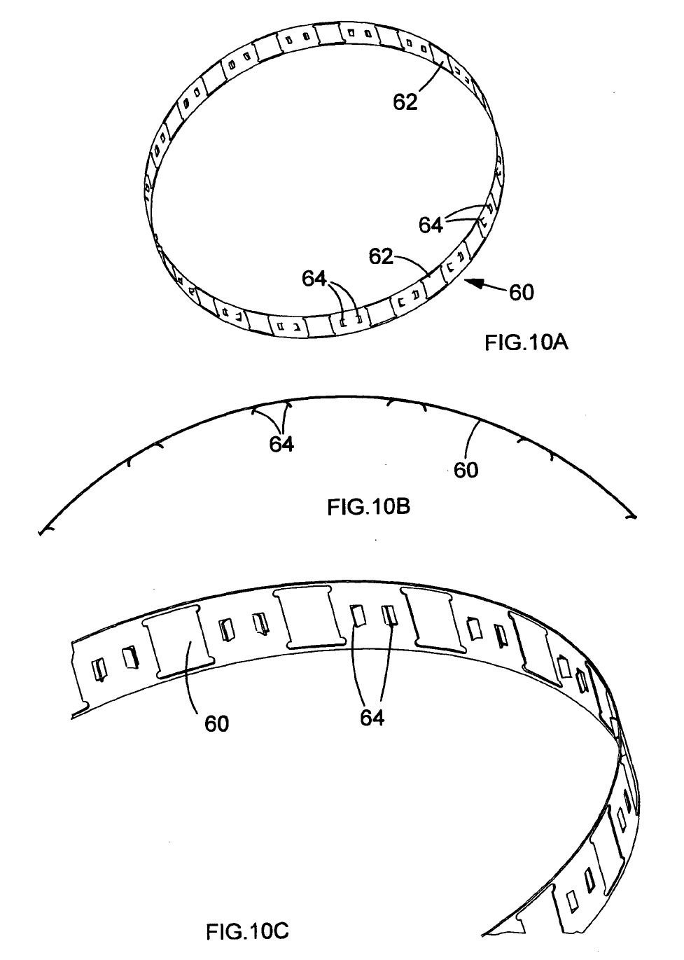

FIGS. 10A, 10B and 10C show parts of a lamination;

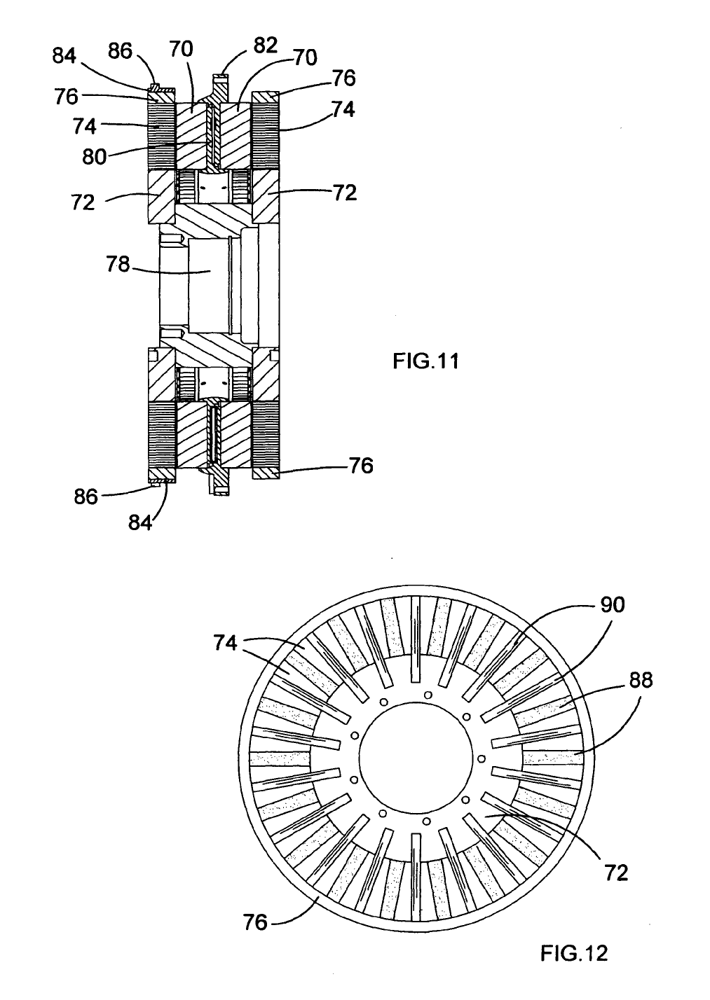

FIG. 11 shows a cross section through parts of another axial flux machine;

FIG. 12 shows a cross section through a rotor;

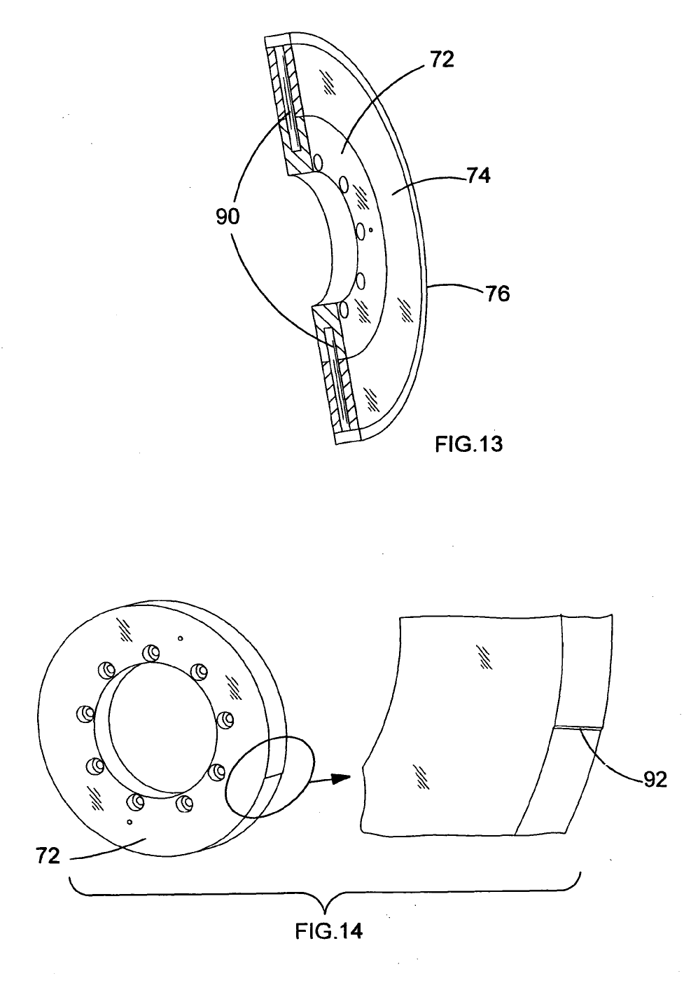

FIG. 13 shows part of a rotor, with a section cut through the rotor;

FIG. 14 shows a detail of an inner ring of a rotor;

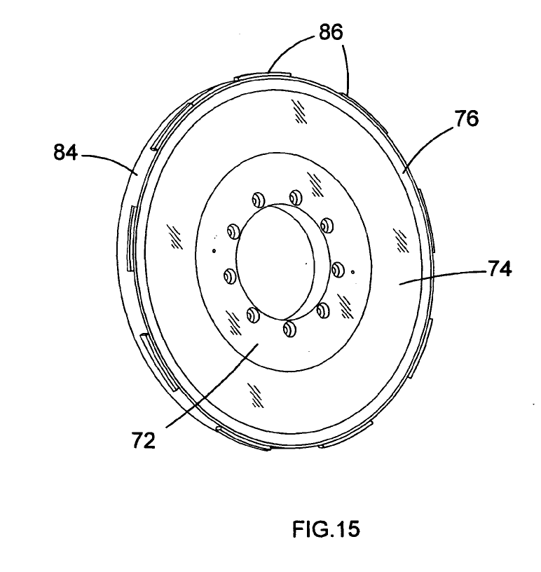

FIG. 15 shows an assembled rotor with an additional ferromagnetic ring;

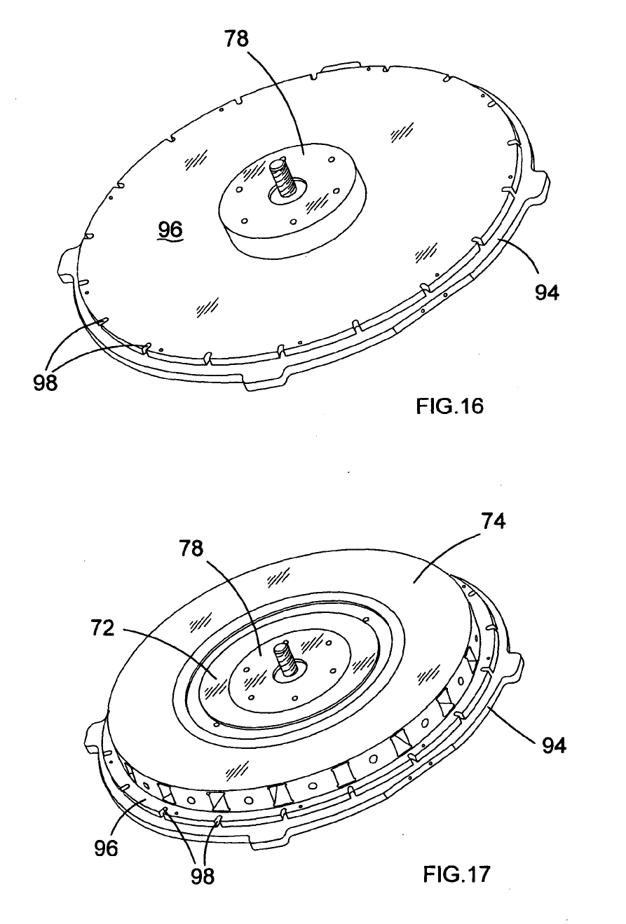

FIGS. 16 to 19 show parts of a drill jig in various stages of assembly for use in manufacturing a rotor;

FIG. 20 shows parts of a magnet insertion tool;

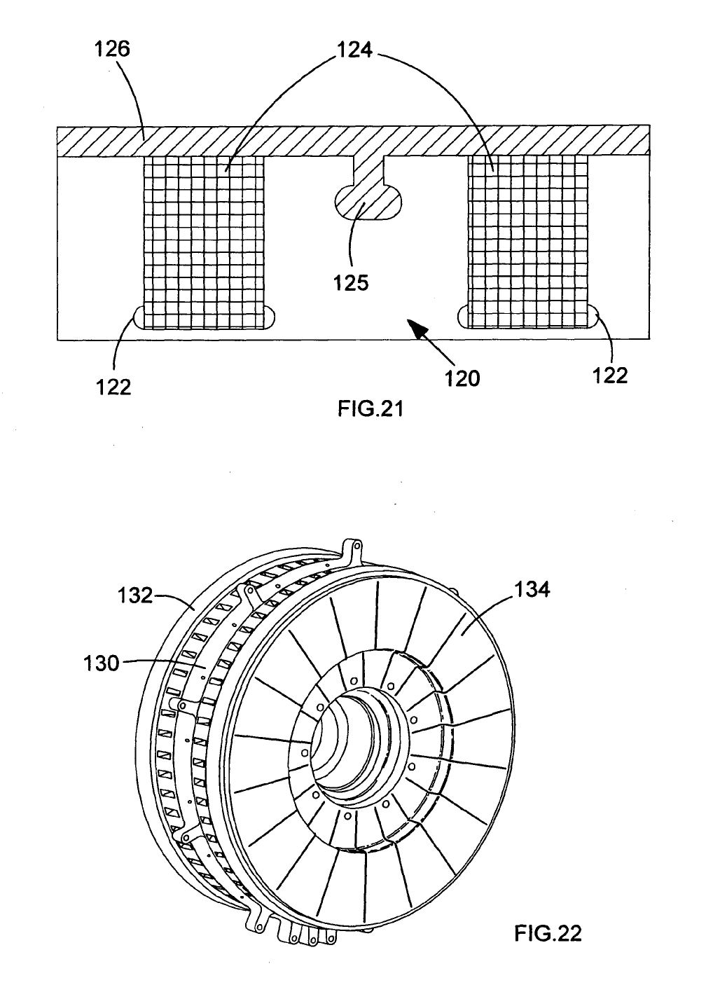

FIG. 21 shows a linearized view of a laminated rotor disc in another embodiment;

FIG. 22 shows parts of an axial flux rotating electrical machine in another embodiment;

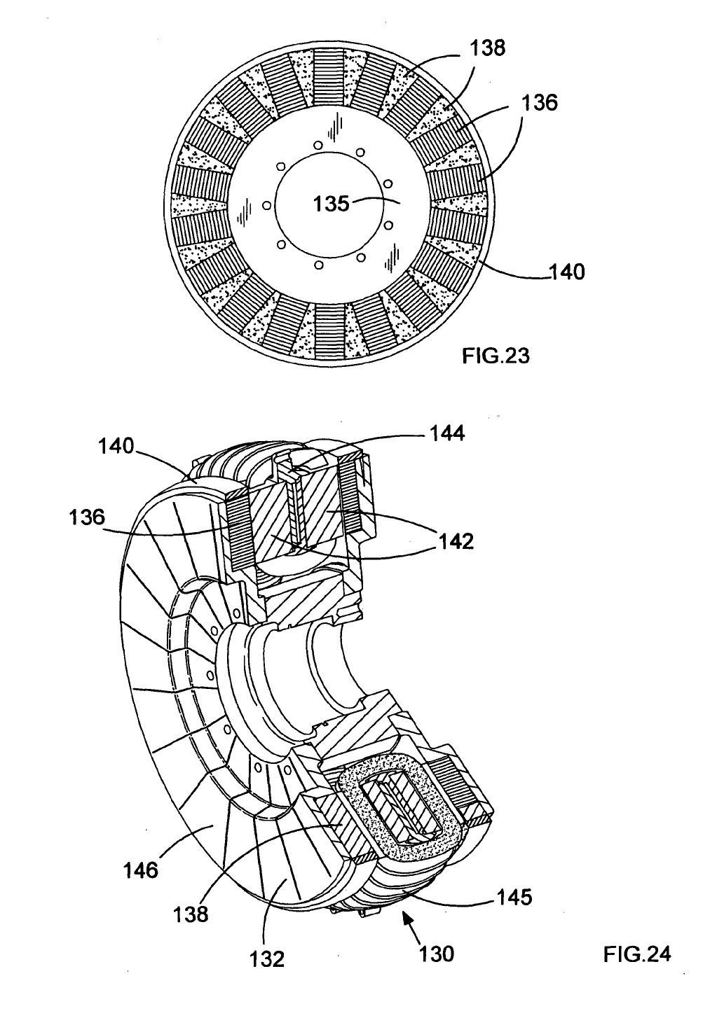

FIG. 23 shows parts of one of the rotors in the arrangement of FIG. 22;

FIG. 24 shows a cut away of an assembled machine;

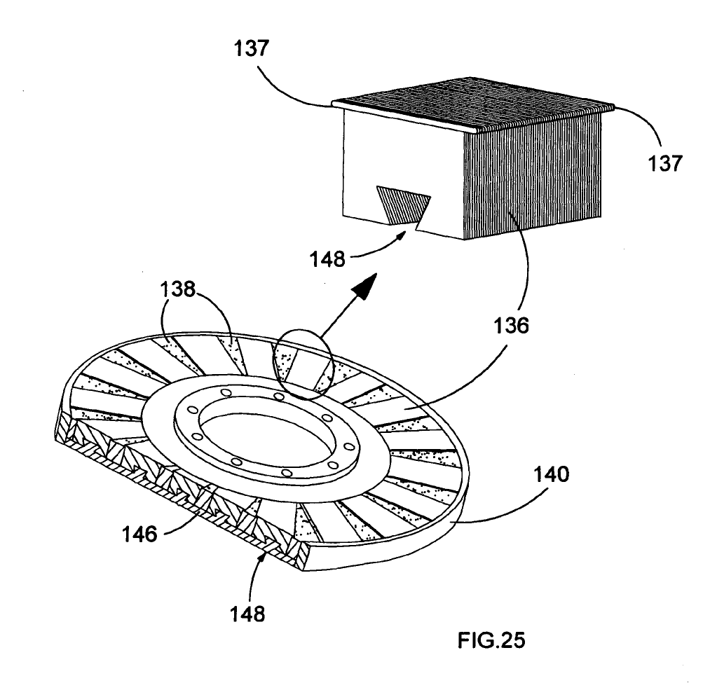

FIG. 25 shows a cut away of the rotor; and

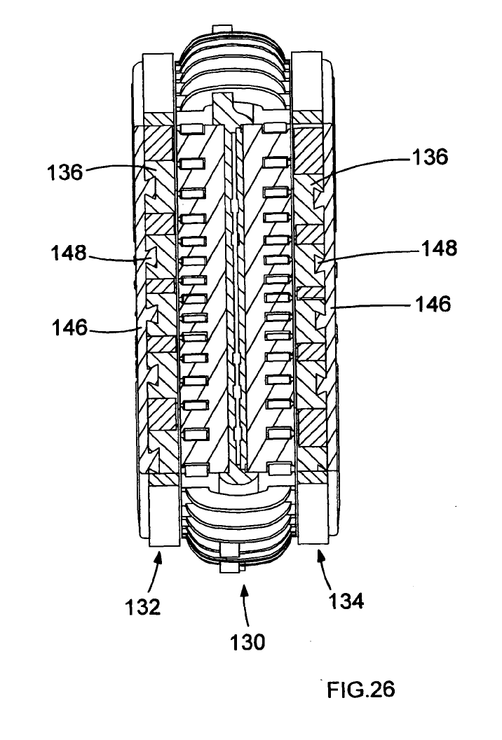

FIG. 26 shows a cross section through an assembled machine.

FIG. 1 shows parts of a rotor for an axial flux permanent magnet rotating electrical machine. Referring to FIG. 1, the rotor comprises a rotor hub 10, a rotor disc 12, and a plurality of permanent magnets 14. In FIG. 1, the permanent magnets 14 are shown outside of the rotor disc. During manufacture of the rotor, the permanent magnets are inserted into slots 16 in the rotor disc. By enclosing the magnets in the rotor disc, the magnets can be mechanically secure even under high centrifugal force such as when the rotor is rotating at high speed and/or when the diameter of rotor is large.

In the arrangement of FIG. 1, the rotor disc 12 is formed from a strip of metal which is wound as a spiral, in order to create a laminated rotor disc. This can allow iron losses in the rotor disc to be reduced. The slots 16 in the rotor disc pass through successive layers of laminations, and are enclosed on each side. The strip of metal is punched prior to winding to make the slots for the magnets. A thin coating of paint-on-resin is applied to the strip of metal prior to winding, in order to fill any voids in the assembled rotor disc, and to give mechanical strength.

Also shown in FIG. 1 is a plurality of bolts 18. The bolts 18 pass radially through the rotor disc 12 and into the rotor hub 10, in order to hold the rotor disc on the rotor hub. The bolts also function to hold the rotor laminations in place.

FIG. 2 shows parts of the rotor with the permanent magnets 14 and the bolts 18 in place. In FIG. 2 the rotor disc 12 is not shown, in order to show the location of the permanent magnets 14 and the bolts 18. However it will be appreciated that in practice the permanent magnets and the bolts will be inside the rotor disc.

In FIG. 2, a retaining ring 20 is shown around the outside circumference of the rotor disc. The retaining ring is placed around the rotor disc once the permanent magnets are in place, and keeps the permanent magnets within the slots in the rotor disc. The retaining ring is made of a non-magnetic material such as stainless steel.

In arrangement of FIG. 2, the bolts 18 are inserted once the retaining ring is in place. The bolts 18 pass through the retaining ring 20 and the rotor disc 12 and into rotor hub 10. In this way, the bolts 18 can be used to hold together the entire rotor assembly consisting of retaining ring, laminated rotor disc, permanent magnets and rotor hub.

FIG. 3A is a diagram showing a profile of the slots for accommodating the permanent magnets. Referring to FIG. 3A, the slots 16 have a substantially rectangular profile, with corners which are rounded in the circumferential direction. The rounded corners help to relieve stress on the laminations and prevent damage to the corners of the magnets when they are inserted into the slots. FIG. 3B shows an alternative profile of the slots. In FIG. 3B, the slots 16 also have a substantially rectangular profile, but with corners which are rounded in the circumferential and axial directions, to provide further stress relief. FIGS. 3A and 3B also show a bolt hole 22 for accommodating a bolt 18.

In the arrangement shown in FIGS. 1, 2 and 3, a ferromagnetic filling agent is inserted into the slots with the magnets. The ferromagnetic filling agent avoids air gaps between the magnets and the slots, which can help to ensure a low reluctance path for the flux produced by the magnets. Moreover, the filling agent improves mechanical rigidity of the rotor, and helps avoiding chipping of the magnet corners.

The rotor disc shown in FIGS. 1, 2 and 3 is designed to be part of an axial flux permanent magnet rotating electrical machine comprising two rotor discs located either side of a stator.

FIG. 4 shows a linearized end view of part of an axial flux permanent magnet rotating electrical machine. Referring to FIG. 4, the machine comprises two rotor discs 24, 26 either side of a stator 28, thereby forming two air gaps 32, 34. Each rotor disc 24, 26 comprises a plurality of permanent magnets 36 located in slots 38 within the disc. The stator 28 comprises slots 30 which accommodate stator windings (not shown). A water jacket 31 is located at the centre of the stator, and is used for cooling.

In FIG. 4, the magnetic flux produced by the various permanent magnets is shown by the dashed lines, with the direction of the flux indicated by the arrows. It can be seen that the poles of the permanent magnets 36 are orientated in a circumferential direction within the respective rotor discs. This is in contrast to a conventional axial flux machine, where the poles of the permanent magnets are orientated in an axial direction. By orientating the poles in a circumferential direction, the thicknesses of the magnets can be increased which can allow the air gap flux density to be made higher. This can increase the power density of the machine, which can allow the total weight and total size to be reduced.

FIG. 5 shows a cross section of part of an axial flux permanent magnet rotating electrical machine. Referring to FIG. 5, two rotor discs 24, 26 are located either side of a stator 28. Each rotor disc 24, 26 comprises a plurality of permanent magnets 36 embedded within the disc. Retaining rings 40, 42 are located around the outside of respective rotor discs 24, 26.

The axial flux machine of the present embodiment is designed to implement a flux weakening technique. This technique imposes current into the direct axis of the machine's pole so that the average flux per pole, as given by permanent magnets, decreases. This is achieved through control of the angle of the current through the stator windings. By introducing inverse-saliency so that the inductance in the quadrature axis is greater than in the direct axis, the machine produces positive reluctance torque alongside magnet torque, when negative direct-axis current is applied.

It has been found that enclosing the permanent magnets in the rotor core allows a larger flux weakening range to be achieved. Furthermore, since the rotor is made of laminations, iron losses due to high order harmonics in the rotor are minimized in field weakening conditions.

In order to implement the flux weakening technique, it is necessary to know the angular position of the rotor. In the arrangement of FIG. 5, this is achieved through the use of a number of magnetic elements 44 on the outer surface of the retaining ring 42. Hall-effect sensors 46 are provided in the machine housing 47 to sense the positions of the magnetic elements.

FIG. 6 shows the retaining ring of this embodiment in more detail. The retaining ring 42 is provided with a number of magnetic elements 44 on its outer surface. Adjacent magnetic elements 44 are separated by 360 spatial electrical degrees (i.e. 360° of a cycle of the electrical current through the stator windings). Thus the number of magnetic elements 44 is equal to the number of poles divided by two. The span of each magnetic element corresponds to 180 spatial electrical degrees. Thus the magnetic elements 44 and the gaps between the magnetic elements are the same size. In this embodiment the retaining ring 42 is made of a non-magnetic material. The magnetic elements may be produced, for example, by using a low temperature plasma spray to create a ferrous layer.

The magnetic elements 44 shown in FIG. 6 enable a three Hall-effect position sensing method. Three Hall-effect sensors 46 are provided in the machine housing to sense the positions of the magnetic elements. The locations of the Hall effect sensors 46 are shown in FIG. 7. The angle between the Hall effect sensors 46 corresponds to 120 spatial electrical degrees. A sensor unit (not shown) is used to deduce the position of the rotor from the signals from the Hall effect sensors 46.

Rather than providing the magnetic elements 44 on the outer surface of the retaining ring, an additional outer ring could instead be provided around the outside of the retaining ring 42. For example, the outer ring could be a magnetic ring with a number of protuberances on its surface.

FIG. 8 shows a cross section of part of a machine in another embodiment. In this case the magnetic elements are provided on a ring which is fixed to the rotor hub.

As discussed above with reference to FIGS. 1 and 2, in one embodiment the rotor of the machine comprises a rotor hub 10 and a rotor disc 12. It is necessary to ensure that the rotor disc is correctly located on the rotor hub, and that peripheral slips are prevented. This may be achieved by providing castellation features on the rotor hub.

FIG. 9 shows an embodiment of the rotor hub, as well as the profile of a corresponding rotor disc. Referring to FIG. 9 the rotor hub 50 comprises a plurality of castellations 52 around one side of its outer surface. These castellations 52 coincide with indentations 54 in the rotor disc 56. The interlocking castellations and indentations lock the rotor disc to the rotor hub, in order to prevent any peripheral slip. Furthermore, the interlocking castellations and indentations prevent the axial force due to magnetic attraction from causing any axial movement of the rotor disc relative to the rotor hub. In addition, where the rotor disc is laminated, the interlocking castellations and indentations ensure that the laminations are locked together.

Instead of or in addition to the castellation feature, roll pins may be provided through the rotor disc and rotor hub.

FIGS. 10A, 10B and 10C show parts of an embodiment of a lamination. In FIG. 10A the lamination is a continuous loop, although in practice the lamination may be part of a spirally wound lamination. Referring to FIGS. 10A-10C, the lamination 60 comprises a plurality of slots 62 which accommodate the permanent magnets. The lamination also comprises a plurality of projections, or “tangs” 64. Each projection protrudes into the space created by the corresponding projection in the adjacent lamination. In this way successive laminations are locked to each other. This prevents slippage between the laminations.

FIG. 11 shows a cross section through parts of an axial flux machine in another embodiment. Referring to FIG. 11, the machine comprises a stator core 70 sandwiched between two rotors, each comprising an inner ring 72, a laminated rotor disc 74, and an outer ring 76. The rotors are both located on a centre hub 78.

In FIG. 11 the stator core includes a cooling jacket 80 which is arranged to cool the inside of the stator. The cooling jacket may be, for example, as described in International patent application number PCT/GB2009/001781, the contents of which are incorporated herein by reference. Outward radial projections 82 on the cooling jacket are used to fix the stator assembly to the machine housing. The radial outward and inward peripheral surfaces of the cooling jacket have a curved profile to complement the curvature of overhangs of stator winding. In this way, the average clearance between the windings and the cooling jacket is reduced, hence improving heat transfer from the windings to the cooling jacket.

In the arrangement of FIG. 11, the outer rings 76 are made of non-magnetic material in order to limit the radial leakage flux. In order to allow position sensing, an additional ring 84 is located around the outside of one of the outer rings. The additional ring 84 is made of magnetic material, and has protuberances 86 which are used to sense the rotor position.

FIG. 12 shows a cross section through one of the rotors. As in previous embodiments, permanent magnets 88 are located in radial slots in the laminated rotor disc 74. Bolts or pins 90 pass through the laminated rotor disc 74 and into the inner ring 72, in order to hold the laminated rotor core in place. In this embodiment, the bolts 90 do not pass through the outer ring 76. In some circumstances this may be preferred to reduce stress on the outer ring, and hence to reduce the likelihood of failure.

FIG. 13 shows part of a rotor, with a section cut through the rotor exposing bolts 90. Each bolt 90 passes through the laminated rotor disc 74 and into the inner ring 72, but does not pass through the outer ring 76.

Rather than bolts, other means of securing the rotor laminations could be used. For example, the rotor laminations could be secured using pins or screws, or with laser welding.

FIG. 14 shows a detail of the inner ring 72. The inner ring includes a step 92 on its outer surface, which has a depth approximately equal to the thickness of a lamination in the laminated rotor disc 74. During manufacture of the rotor, the rotor disc 74 is spiral wound onto the inner ring 72. At the start of the winding processes, the end of the lamination is butted against the step 92. In this way, the laminated rotor disc 74 is fully supported by the inner ring 72 around its entire circumference, which increases stability of the rotor disc.

FIG. 15 shows an assembled rotor with an additional ferromagnetic ring 84 having protuberances 86. In the assembled machine, the positions of the protuberances 86 can be sensed using a Hall-effect sensor in the machine housing, as described above.

FIGS. 16 to 19 show parts of a drill jig in various stages of assembly which may be used to drill the holes for the radial bolts 90. The purpose of the drill jig is to position accurately the bolt holes so as to enable the bolts to provide mechanical stability to the rotor plate.

Referring to FIG. 16, a base plate 94 is first secured to the bed of a drilling machine. The base plate is located on the bed using two dowels, and then is clamped in position. An indexing plate 96 is then placed on the base plate 94, followed by the centre hub 78. The indexing plate 96 and centre hub 78 have a central bearing which allow them to be rotated about the rotor axis. The indexing plate 96 has indexing slots 98 around its circumference.

Referring to FIG. 17, the inner ring 72 is placed around the centre hub 78, and the laminated rotor disc 74 is spiral wound around the inner ring.

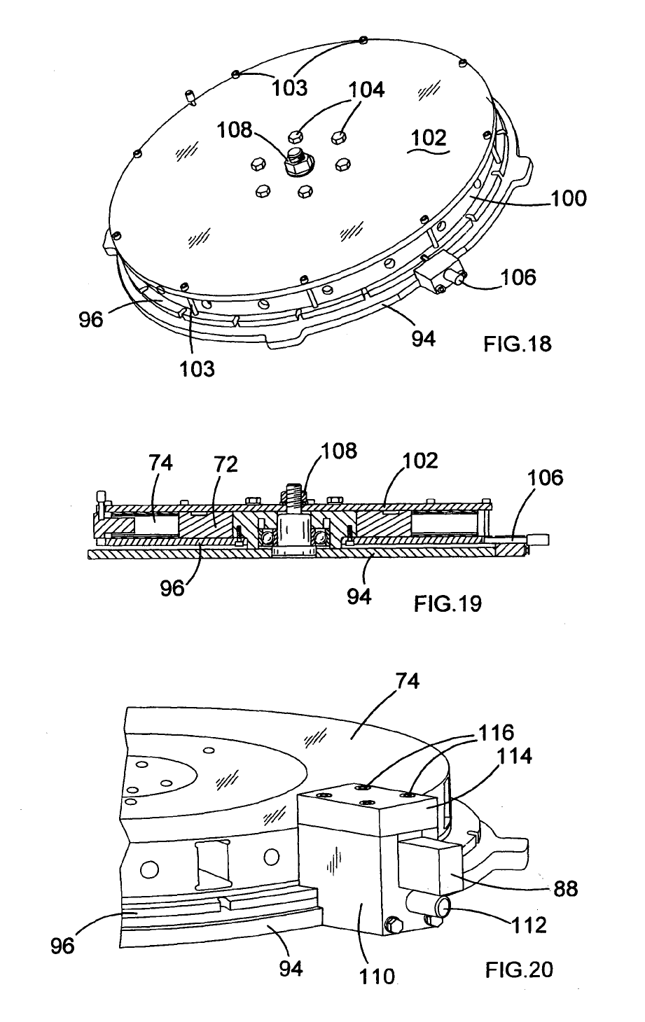

Referring to FIG. 18, a clamping ring 100 is tightened around the laminated rotor disc to prevent separation of the laminations during drilling. The clamping ring 100 is located on the rotor disc using a taper peg which fits into one of the magnet slots, and a location pin through a top clamp plate 102. The clamp plate 102 is placed on top of the rotor disc, and is clamped using screws 103 into the outer circumference of the indexing plate, and screws 104 into the centre hub.

The clamped rotor assembly is located by inserting an index pin 106 into one of the indexing slots 98 in the indexing plate 96. A central nut 108 is then tightened to fix the assembly in position. A bolt hole can then be drilled through the rotor disc and into the inner ring. Each subsequent hole can be positioned for drilling by slackening the central nut 108, withdrawing the indexing pin 106, and rotating the assembly to the next slot position. The indexing pin is then reinserted and the central nut retightened.

A cross section through the assembly is shown in FIG. 19. The same parts are given the same reference numerals as previously.

FIG. 20 shows parts of a magnet insertion tool for inserting the permanent magnets 88 into the slots. The drill jig base plate 94 and indexing plate 96 are used for inserting the magnets. A magnet guide block 110 with an index pin 112 is assembled on to the base plate 94. A nylon clamp block 114 is assembled to the guide block 110 using mounting screws 116, and springs under the mounting screws to apply a load to restrain the magnet 88 during the insertion process. The magnet 88 is then pushed radially into the slot in the rotor disc. A gap fill compound is used to fill any voids around each magnet to prevent movement during machine operation.

In any of the above embodiments there may exist a gap between the magnets and the slots due to allowances made in sizing to accommodate variations in tolerances. For this reason it may be desirable to include a gap filling agent in the slots. A gap filling agent with magnetic properties would be beneficial in order to provide a low reluctance path for the magnetic flux. However, the filling process may be difficult to control if the filling agent has magnetic particles which are attracted towards the magnets. For this reason, a non-magnetic gap filling agent may be preferred. The gap fill agent preferably has the properties of elasticity, resistance to high temperatures, and not reacting with the rotor or magnet materials. The property of elasticity allows the movement of magnets within the slots to be dampened.

Since the rotor disc comprises laminations, the radial positions of the centres of gravity of the permanent magnets are offset at most by the thickness of the laminations. Variable width spacers may be introduced into the slots in order to keep the centres of gravity of the magnets at the same radius.

In any of the embodiments described above, the machine may be designed for operation as a traction motor-generator. Wide constant output power speed range may be achieved through field weakening. The machine may adopt an inverse-salient electromagnetic design by having permanent magnets embedded into the rotor disc. The laminated design provides flexibility by allowing the size of the magnets to be adjusted to meet the required specification. In addition, the laminated design reduces iron losses in the rotor. The rotor's mechanical rigidity may be increased by bolting the rotor disc to the rotor centre hub. An outer retaining ring equalizes distribution of mechanical pre-load to the rotor lamination. A different option provides a pair of indentation features per magnet, which interlocks the lamination and avoids tangential movement so that the entire structure is kept under mechanical pre-load.

Some of the advantages of various embodiments of the machine are as follows:
The machine topology allows tailoring of electrical parameters (inductances, saliency ratio) to meet specific requirements for traction drive by means of field weakening.
Since the rotor is made of laminations, the rotor or magnet shape can be adjusted for fine tuning (for example, variable profile of the air gap).
Reduction of iron losses due to laminated rotor structure.
Higher level of mechanical damping in comparison to solid rotor plate topology.
Stress relieving features around the magnet corners.
Ferromagnetic filling agent suppresses air gaps which would otherwise be caused by the stress relieving features and clearances between the magnet and the rotor. Moreover, the filling agent improves mechanical rigidity of the rotor since it effectively glues the magnets to the rotor. Moreover, it helps to avoid chipping of the magnet corners which may occur because of their mechanical loading.
Outer retaining ring shrinks on the top of the laminated rotor pack and holds the magnets in their position, as well as increasing the stiffness of the rotor assembly.
Extra features on the retaining ring are possible for three Hall-effect position sensing method.
The features used to sense the position can also be created on top of a non-magnetic outer ring with a ferrous layer by using low temperature plasma spray.
Rotor lamination is fixed to the rotor hub by a set of bolts equally distributed around the circumference of the machine.
Castellation feature on the rotor hub, and corresponding indentations on the wound-lamination, locks the lamination with the hub in order to stop any peripheral slips, and restrains any axial movement due to the axial force due to magnetic attraction.
The functions that are achieved with castellation feature can also be achieved by having roll-pins. This may be advantageous in terms of simple manufacturing process.
Indentation features on rotor laminations may overcome functionality requirements of bolts by interlocking of laminations.
Radially placed bolts hold together the rotor assembly of the retaining ring, rotor lamination, magnets and the rotor hub.

In a typical rotor design, the rotor has an open magnetic circuit. This may complicate manufacture of the rotor, since any magnetic elements which come into proximity of the rotor, such as tools used during the manufacturing process, will be attracted to the rotor. The open magnetic circuit may also contribute to leakage flux.

Some previously considered rotor designs are relatively complex, making manufacture difficult. It would therefore be desirable to provide a simple rotor design. It would also be desirable to provide a rotor design with a surface which can be used as an interface for other components, such as a clutch. It is also desirable to reduce the inertia of the rotor where possible.

FIGS. 21 to 26 show details of some alternative rotor designs. These rotor designs are designed to address at least some of the above issues.

FIG. 21 shows a linearized view of a laminated rotor disc in another embodiment. The laminated rotor disc 120 comprises slots 122 which accommodate permanent magnets 124. In this arrangement, the slots 122 in the laminated rotor disc are open on the side of the rotor which faces away from the stator, and closed on the side which faces towards the stator. A back plate 126 is provided in order to close the slots. The back plate may be made of cast aluminium, or any other suitable non-magnetic material. The back plate has a protrusion 125 which fits into a corresponding recess in the laminations, in order to hold the two together.

With the arrangement of FIG. 21 the leakage flux from the magnets may be reduced, since a non-magnetic material is present on the side of the rotor away from the stator. Furthermore this arrangement may help to give the rotor mechanical stability.

FIG. 22 shows parts of an axial flux rotating electrical machine in another embodiment. The machine comprises a water cooled stator 130 sandwiched between two rotors 132, 134. Each rotor consists of groups of steel laminations with a cast aluminium back plate.

FIG. 23 shows parts of one of the rotors in the arrangement of FIG. 22. The rotor comprises a plurality of groups of laminations 136 which are located circumferentially about a rotor hub 135. A plurality of permanent magnets 138 are inserted between the groups of laminations 136. In this arrangement, the permanent magnets 138 are tapered. An outer ring 140 is shrunk fit around the laminations 136 and magnets 138.

FIG. 24 shows a cut away of an assembled machine. Referring to FIG. 24, the stator 130 comprises stator cores 142, a water jacket heat sink 144 inside the stator cores, and stator windings 145. The rotor 132 comprises groups of laminated steel strips 136, magnets 138, outer ring 140, and back plate 146.

FIG. 25 shows a cut away of the rotor showing the rotor design in more detail. In the arrangement of FIG. 25, the groups of laminations 136 comprise dovetail features 148. Each dovetail feature is a recess in the laminations, with a width which increases away from its opening. The back plate 146 has corresponding protrusions with a width which diminishes towards the root. This arrangement can help to ensure a mechanically stable design.

In the arrangement of FIG. 25, the groups of laminations 136 have flanges 137 on the side of the rotor facing the stator. The flanges each are used to retain the permanent magnets. However, in this arrangement the flanges do not completely close the slots in which the magnets are accommodated. As a consequence, the magnets are partially exposed on the side of the rotor which faces the stator.

FIG. 26 shows a cross section through an assembled machine, showing the dovetail features 148.

In the arrangements described above the back plate 146 may be cast onto the partially-formed rotor. This may be achieved by using the partially-formed rotor as part of a mould. For example, the partially-formed rotor may be partially submerged into molten aluminium, and the aluminium allowed to set. This may facilitate the formation of the dovetail features, and allow the laminations to be securely fixed to the back plate.

The arrangement shown in FIGS. 21 to 26 may provide a reduction in leakage flux in comparison to some previous designs. It may also allow the magnet mass to be reduced, thereby reducing the inertia of the rotor. Furthermore, the design may be easier to manufacture, and may result in a mechanically more stable rotor. In addition, the back plate may provide a surface to which other components, such as a clutch, can be attached.

1-39. (canceled)

40. A rotor for an axial flux permanent magnet rotating electrical machine, the rotor comprising:
a rotor disc, the rotor disc comprising a plurality of laminations in a radial direction through the rotor disc;
a plurality of permanent magnets accommodated in slots which pass radially through successive laminations in the rotor disc;
a rotor hub; and
a plurality of radial bolts which pass through the rotor disc to the rotor hub.

41. A rotor according to claim 40, wherein the slots are open at the outer circumference of the rotor disc.

42. A rotor according to claim 40, wherein the rotor disc is spiral wound onto the rotor hub.

43. A rotor according to claim 40, wherein the rotor disc is formed from a spirally wound strip of material which comprises a coating of resin which provides mechanical strength to the assembled rotor disc.

44. A rotor according to claim 40, wherein the rotor disc is formed from a spirally wound strip of material, and the strip of material is punched to make pockets for the magnets prior to forming the laminated rotor disc.

45. A rotor according to claim 40, wherein a lamination in the rotor disc comprises a projection which protrudes into a space in an adjacent lamination.

46. A rotor according to claim 40, wherein the slots are rounded outwardly at the corners.

47. A rotor according to claim 40, further comprising a retaining ring around the circumference of the rotor disc.

48. A rotor according to claim 47, where the retaining ring is secured to the rotor disc by means of the radial bolts.

49. A rotor according to claim 47, wherein the retaining ring comprises a plurality of magnetic elements.

50. A rotor according to claim 40, wherein the rotor hub and rotor disc are provided with corresponding protrusions and indentations which interlock with each other.

51. A rotor according to claim 40, wherein the rotor hub is provided with a step on its outer surface, and an end of a lamination is butted against the step.

52. A rotor according to claim 40, wherein the permanent magnets have poles which are orientated in a circumferential direction within the rotor disc.

53. A rotor according to claim 40, wherein the slots in the rotor disc are open on a side of the rotor disc which faces away from a stator, and the rotor further comprises a back plate which closes the slots.

54. A rotor according to claim 53, wherein the back plate is cast onto the laminations.

55. A rotor according to claim 40, wherein the slots are at least partially open on a side of the rotor that faces a stator.

56. A rotor according to claim 40, wherein the permanent magnets are tapered.

57. An axial flux permanent magnet rotating electrical machine comprising a stator and a rotor, the rotor comprising:
a rotor disc, the rotor disc comprising a plurality of laminations in a radial direction through the rotor disc;
a plurality of permanent magnets accommodated in slots which pass radially through successive laminations in the rotor disc;
a rotor hub; and
a plurality of radial bolts which pass through the rotor disc to the rotor hub.

58. A method of manufacturing a rotor for an axial flux permanent magnet rotating electrical machine, the method comprising:
forming a rotor disc from a plurality of laminations which run in a radial direction through the rotor disc, the laminations having a plurality of slots which pass radially through successive laminations for accommodating permanent magnets; and
securing the rotor disc to a rotor hub with a plurality of radial bolts which pass through the rotor disc to the rotor hub.

59. A method according to claim 58, wherein the rotor disc is spiral wound onto the rotor hub.
